(19) United States
(12) Patent Application Publication
(10) Pub. No.: US 2010/0015457 A1
(43) Pub. Date: Jan. 21, 2010

(54) WATER-BASED POLYURETHANE FLOOR COATING COMPOSITION

(76) Inventors: Mitchell T. Johnson, Gig Harbor, WA (US); Khiza L. Mazwi, Los Angeles, CA (US)

Correspondence Address: 3M INNOVATIVE PROPERTIES COMPANY, PO BOX 33427, ST. PAUL, MN, 55133-3427, US

(21) Appl. No.: 12/303,340

(22) PCT Filed: Jun. 6, 2007
(86) PCT No.: PCT/US07/70487

§ 371 Date: Jul. 9, 2009

(30) Foreign Application Priority Data
Jun. 8, 2006 (US) 11423061

(51) Int. Cl. B32B 27/30; C09D 175/04; B32B 9/00; B05D 7/00; C23F 1/00

(52) U.S. Cl. 428/500; 252/183.11; 524/539; 428/704; 524/507; 427/402; 216/83; 216/37

(57) ABSTRACT

A water-based coating composition that is particularly suited as a floor coating. The composition is an aqueous two-part or two-component polyurethane system, having a water-dispersible polyisocyanate component and a hard cyclic diol component. The composition may be applied over a primer coating. The composition can be applied as a fairly thin coating, e.g., less than 127 micrometers (5 mils) thick, and provides a suitable coating with one coat. The composition, when coated onto a surface such as a floor, can be cured under ambient conditions. The resulting coating provides a durable coating with high gloss.

### FIELD OF THE DISCLOSURE

The present disclosure relates to a water-based two-part polyurethane finish composition useful for providing a coating or film to a substrate surface such as a floor.

### BACKGROUND OF THE DISCLOSURE

Polymer compositions are used in various coating compositions such as floor finishes or polishes, for example. Commercially available floor finish compositions typically are aqueous emulsion-based polymer compositions comprising one or more organic solvents, plasticizers, coating aides, anti-foaming agents, polymer emulsions, metal complexing agents, waxes, and the like. The polymer composition is applied to a floor surface and then allowed to react and dry in air, normally at ambient temperature and humidity. A film is formed that serves as a protective barrier against soil deposited on the floor by pedestrian traffic, for example. These same polymer compositions can be applied to other substrate surfaces for which protection is desired, such as tile floors, walls, furniture, windows, counter tops, and bathroom surfaces, to name but a few.

Although many of the commercially available aqueous floor finishes have performed well and have experienced at least some commercial success, opportunities for improvement remain. In particular, it is highly desirable that the resultant floor finish film exhibits certain physical and performance characteristics including overall durability, hardness, scratch resistance, soil resistance, black marks/scuff resistance, abrasion resistance, and high gloss. Further, it is highly desirable to have a floor finish material that is easy to apply.

### SUMMARY OF THE DISCLOSURE

The present disclosure provides a reactive coating composition that, upon curing, is particularly suited as a floor coating. The composition is an aqueous two-part or two-component polyurethane reactive system, having a water-dispersible polyisocyanate component and a cyclic diol hard segment component. After the two components are mixed, the reactive composition can be applied as a fairly thin coating, e.g., less than 127 micrometers (5 mils) thick. The reactive composition, when coated onto a surface such as a floor, can be cured and dried under ambient conditions. After curing and drying, the resulting reacted coating provides a durable finish with a high gloss, often with one coat. This disclosure provides a reactive composition comprising a first component or first reactive comprising a water-dispersible isocyanate, and a second component or second reactive comprising a cyclic aliphatic alcohol, such as a cyclohexanedimethanol. In some embodiments, the cyclohexanedimethanol is 1,4-cyclohexanedimethanol. In some embodiments, the first component consists of water-dispersible isocyanate, and the second component consists of cyclohexanedimethanol and water. Optional additives may be present in the first component, in the second component, or added to the reactive composition after the first component has been mixed with the second component.

This disclosure also provides a method for making a reactive composition, the method including providing a first component comprising a water-dispersible isocyanate in a first vessel, and providing a second component comprising cyclohexanedimethanol in a second vessel, and then combining the first component with the second component to provide the reactive composition. In some embodiments the first and second vessels comprise a multi-compartment plastic bag or pouch with rupturable inner seals between compartments. The combining step may include rupturing of the seal between components and mixing of the components by kneading. Other ingredients may be present in the first component, in the second component, and/or in the reactive composition.

Yet another aspect of this disclosure is a method of applying a reactive composition to a surface. The method includes combining a first component comprising a water-dispersible isocyanate with a second component comprising a cyclohexanedimethanol to provide a reactive composition, and then applying the reactive composition to a surface. In many embodiments, the surface is a floor, such as a tile floor or a linoleum floor. The reactive composition may be applied at a thickness of no more than about 127 micrometers (5 mils), or more than about 51 micrometers (2 mils). In some embodiments the reactive composition is applied to a primed surface. Typically the primer is a acrylic latex containing an alkali-soluble resin. The overall thickness of the primer and reactive composition is generally between about 25.6 to about 81.3 micrometers (1.01-3.2 mils) when dried.

Yet another aspect of this disclosure is a method for stripping a coating from a surface, by applying a stripper to a coated surface. The coating comprises a primer coating layer and a reactive composition coating layer on top of the primer coating layer.

This disclosure also provides a method for treating a surface comprising the steps of applying a primer; allowing the primer to dry; applying a reactive composition comprising water-dispersible isocyanate, cyclohexanedimethanol and water; allowing the reactive composition to cure and dry; and stripping off the primer and coating composition layers with a stripper.

These and other embodiments and aspects are within the scope of this disclosure.

### BRIEF DESCRIPTION OF THE DRAWINGS

FIG. 1 is a perspective view of a user using an applicator system for applying the reactive coating composition of the present disclosure to a floor.

FIG. 2 is a perspective view a portion of the applicator system of FIG. 1, particularly, an applicator device;

FIG. 3 is a perspective view of a portion of the applicator device of FIG. 2, particularly, an application head; and

FIG. 4 is an end view of the application head of FIG. 3.

### DETAILED DESCRIPTION

The present disclosure provides a reactive coating composition that is a two-part or two-component system, which upon combining of the two parts, provides an aqueous reactive polyurethane composition suitable for use as floor coating. The reactive composition includes a water-dispersible polyisocyanate component or reactant and a cyclic diol hard segment component or reactant. Individual components of the composition are described in greater detail below. The composition is easy to apply to a surface, such as a floor.

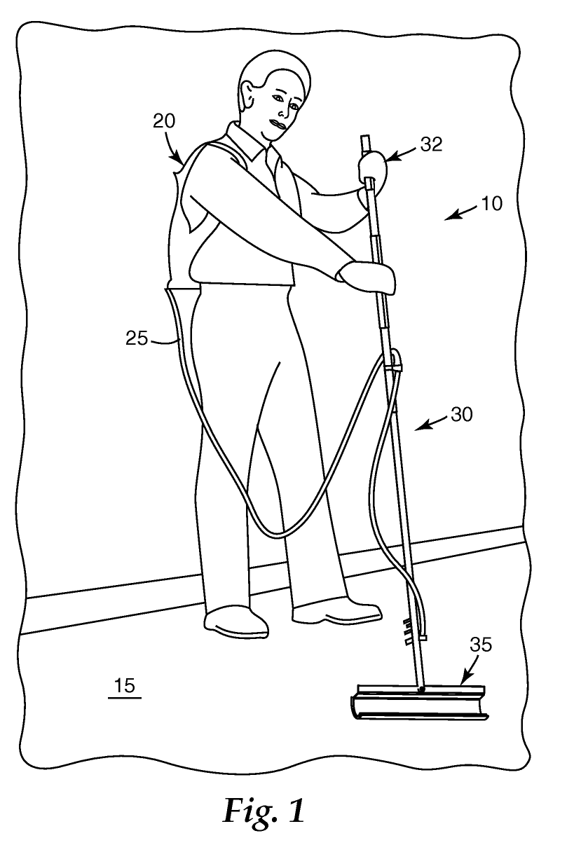

Referring to the figures, a system for applying the reactive coating composition to a surface, such as a floor, is illustrated. Illustrated in FIG. 1 is a user with an exemplary coating applicator system 10 applying a liquid coating composition onto floor 15. Applicator system 10 includes a liquid retainer 20 for storing the liquid coating composition prior to application to floor 15 and an applicator device 30 that applies the liquid coating to floor 15. Liquid retainer 20 may have two separate compartments (not seen) for separating the two components of the coating composition until ready to be combined (e.g., reacted) and then dispensed and applied. A hose or other connecting passage 25 provides liquid coating composition from retainer 20 to applicator device 30.

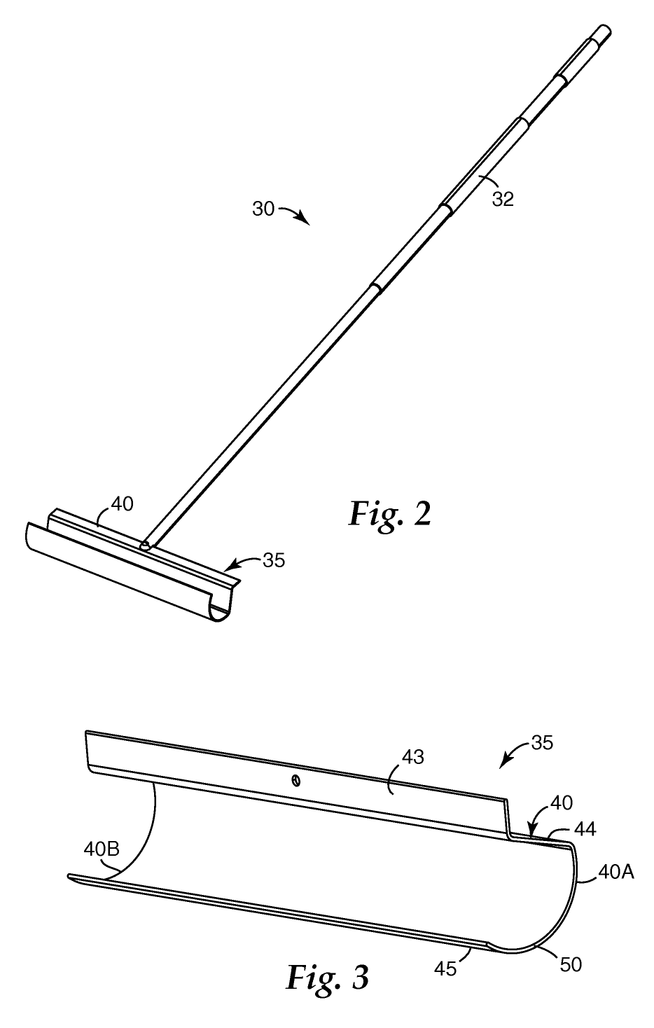

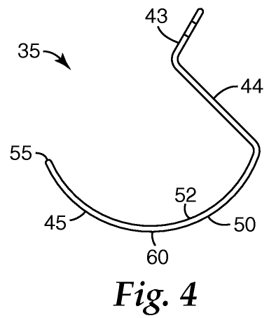

Applicator device 30, also seen in FIG. 2, has a handle 32 connected to an application head 35, which is shown in more detail in FIGS. 3 and 4. Application head 35 has a body 40 with a first end 40A and an opposite second end 40B. Body 40 includes a first portion 43 for connecting to handle 32 and a second portion 45 which is configured for application of the liquid composition onto floor 15. Present between first portion 43 and second portion 45 is a transition portion 44.

Second portion 45, within outer surface 50 and an inner surface 52 has an arcuate shape terminating at tip 55. Second portion 45 includes a contact area 60 on outer surface 50. Contact area 60 extends from first end 40A to second end 40B in the longitudinal direction of second portion 45, which is the direction between tip 55 and where second portion 45 meets with transition portion 44.

The various portions of body 40, e.g., first portion 43, second portion 45 and transition portion 44, can be formed from a sheet of material, such as thermoplastic. In most embodiments, body 40 is at least partially flexible or deformable, particularly at second portion 45, when a force is applied to body 40 at first portion 43. In some designs of application head 35, body 40 is sufficiently flexible so that the depth of contact area 60, i.e., in the longitudinal direction, is about 1 inch.

In some embodiments, application head 35 is used in conjunction with an applicator pad, which are generally well known for applicator systems. Examples of suitable pads include microfiber pads, fleece, and foam.

Additional details regarding applicator system 10 and variations thereof are disclosed in co-pending patent application having attorney docket no. 62025US002, filed on even date herewith, the entire disclosure of which is incorporated by reference.

It should be understood that applicator system 10 and the various features thereof that have been described herein and in co-pending patent application having attorney docket no. 62025US002 are only examples of suitable systems for applying the liquid coating composition of the present disclosure onto a surface. Other applicator systems can also be used. For example, additional embodiments of applicator heads, other than just applicator head 35, are disclosed in co-pending patent application having attorney docket no. 62025US002.

In some instances the surface to be coated may be prepared, for example, by cleaning, stripping to remove previous coatings, and/or priming.

In some embodiments a primer composition is applied to the surface prior to the application of the reactive coating composition of this disclosure. A wide variety of primer compositions may be used for this purpose. Primer compositions that are particularly useful include compositions which by themselves can function as surface coating compositions, such as, for example, aqueous coating compositions. In this way, if areas of the surface are inadvertently or intentionally not covered with the reactive coating composition of this disclosure, the primer coating provides a visually pleasing and/or protective coating.

Typically the primer composition comprises an acrylic latex and an alkali-soluble resin. Acrylic latexes are generally emulsion polymers formed from acrylic and/or other ethylenically unsaturated monomers. Techniques for the preparation of emulsion polymers is well known to those skilled in the art. Generally such emulsion polymers are prepared with ethylenically unsaturated monomers, initiators, surfactants or polymeric emulsifying agents and water.

The acrylic latexes typically contain acrylic polymers, acrylic copolymers, styrene-acrylic copolymers, or blends thereof. Acrylic polymers contain only one type of acrylate monomer whereas the acrylic copolymers comprise two or more different types of acrylate monomers. Styrene-acrylic copolymers comprise at least one type of styrene monomer and at least one type of acrylate monomer. Representative examples of the acrylate monomers include, for example, acrylic acid, butyl acrylate, ethyl acrylate, methyl acrylate, 2-ethyl hexyl acrylate, acrylonitrile, acrylamide, methacrylic acid, methyl methacrylate, ethyl methacrylate, butyl methacrylate, methacrylamide, and the like. Examples of styrene monomers include styrene, alpha-methyl styrene, and the like.

Examples of suitable acrylic latexes include, for example, DURAPLUS 2 or DURAPLUS 3 modified acrylic floor polishes or ROSHIELD 3275 acrylic emulsion commercially available from Rohm and Haas, Philadelphia, Pa. Examples of other commercially available acrylic polymers or copolymers include MEGATRAN 240, MEGATRAN 228 or SYNTRAN 1921 from Interpolymer, Canton, Mass.

Examples of commercially available styrene-acrylic copolymers include, styrene/methyl methacrylate/butyl acrylate/methacrylic acid (S/MMA/BA/MAA) copolymers, styrene/methyl methacrylate/butyl acrylate/acrylic acid (S/MMA/BA/AA) copolymers, and the like, S/MMA/BA/MAA and S/MMA/BA/AA copolymers such as MOR-GLO-2 commercially available from OMNOVA Solutions, Inc. of Chester, S.C.

The alkali-soluble resins generally include copolymers of styrene or vinyl toluene with at least one alpha-beta-monoethylenically unsaturated acid or anhydride such as styrene-maleic anhydride resins, rosin/maleic anhydride adducts which are condensed with polyols, and the like. The alkali-soluble resins typically have a weight average molecular weight from about 500 to 10,000 and or more typically from about 1000 to 5000. The resins are often used as a conventional resin cut, which is an aqueous solution of the resin with an alkaline substance having a fugitive cation such as ammonium hydroxide. The alkali-soluble resin is typically used in amounts from 1 to about 20 weight percent, or in amounts from 1 to about 15 weight percent, based on the weight of the primer composition.

The primer composition may also contain one or more other additives so long as the additives do not interfere with priming ability of the primer composition. Examples of additives include polyvalent metal compounds, solvents, additional reactive or non-reactive acrylic compositions, reactive or non-reactive polyester compositions such as, for example, polyester polyols, surfactants, permanent and fugitive plasticizers, defoamers, wetting agents, and biocides.

Generally, it is desirable to apply the primer composition as a single coat. This means that one coating of primer is generally sufficient to provide the priming characteristics desirable for use with reactive coating composition of this disclosure. Additional coats of primer composition may be applied if desired. It is generally desirable that the thickness of the primer layer be in the range of about 0.254 to about 5.08 micrometers (0.01-0.20 mils) when dried.

The primer may be applied using any conventional application techniques. The primer compositions may be applied with a mop, sponge, roller, cloth, brush, pad or any other suitable tools such at T-bar applicators, application dispensing tools or spray application equipment. One particularly suitable applicator is the mop assembly and cart disclosed in U.S. Pat. No. 6,854,912 (Dyer et al).

If used, it is desirable that the primer layer have good adhesion for the reactive coating composition of this disclosure. This adhesion can be determined for example through the use of a modification of the test method ASTM D-3359 (where generally a rating of 4B or higher indicates practical utility), by cutting through the cured coating and primer layers on a test tile with a razor blade to form a grid of 0.32 centimeter by 0.32 centimeter squares (⅛ inch by ⅛ inch). A tape such as “SCOTCH Rug and Carpet tape” commercially available from 3M Company, St. Paul, Minn. is then applied over the squares, rolled down with a 2 kilogram roller, and peeled back by hand at a 180° angle. Adhesion can be determined by inspection of the tile and the tape to determine the quantity of squares removed. If there is 100% adhesion, no squares are removed from the tile. Generally, the primer and reactive coating compositions of the present disclosure, when tested, have 100% adhesion or nearly 100% adhesion.

It is also desirable that the primer be one that is easily removed or stripped from the surface. The ease of removal of the primer layer aids in the removal of the cured coating above the primer layer.

Generally any stripper suitable for removing the primer composition is a useful stripper for this use. Examples of useful strippers for removing the primer and cured coatings include “Twist'n Fill No 6H Speed Stripper” or “3M Twist'n Fill No 22H, Low Odor Stripper”, commercially available from 3M Company, St. Paul, Minn. as well as other benzyl alcohol/amine-based stripper compositions. In addition, water-based strippers that contain alkali salts are also useful. Many such compositions are known and commercially available, generally in concentrated form which may be diluted prior to use. The required dwell time of the stripper to effect adequate removal of the coated substrate will depend on the ready-to-use concentration of the non-aqueous components.

As provided above, the reactive coating composition of this disclosure includes a reactive mixture of a water-dispersible polyisocyanate component and a cyclic diol hard segment component Generally, the polyisocyanate component and the cyclic diol hard segment component are kept separate until they are mixed, after which they begin to react and are thus ready for application onto a surface. The two components are mixed, preferably thoroughly mixed to be homogeneous, to form a reactive coating composition. Generally, the two components begin reacting with each other upon contact.

Prior to mixing, the polyisocyanate component and the cyclic diol hard segment component are preferably stored separately in air-tight vessels until they are ready to be mixed. Reducing the exposure to air and moisture during storage is believed to retain reactivity of the individual components as well as reduce the potential for air entrainment and bubble formation in each individual component and when the components are mixed. The coating applicator system may include a mixing nozzle or other element to combine the two components as they are dispensed from their individual vessels. For example, referring to coating applicator system 10, retainer 20 can have two compartments, one for the polyisocyanate component and one for the cyclic diol hard segment component. Connecting passage 25, which extends from retainer 20, can have mixing elements at the entrance or throughout at least a portion of its length to thoroughly mix the two components as they flow towards applicator device 30. In such a system, however, care should be taken so that the two individual components are mixed at proper ratios.

A preferred coating applicator system includes a multi-compartment plastic bag or pouch, one for each of the components, which have internal seals that are readily and controllably rupturable. To mix the components, the internal divider between the two pouches is ruptured and the individual components are mixed, for example, by kneading. The mixed components are dispensed from the pouch as a reactive composition.

One preferred storage system for the two components, which also functions as a dispensing unit, is described in PCT publication WO 2004/108404, the entire disclosure of which is incorporated by reference. This publication discloses various embodiments of multi-compartment plastic bags or pouches.

In some embodiments, depending on the specific polyisocyanate component and the specific cyclic diol hard segment component used, the mixed composition may undergo a color change due to the reaction between the two components. For example, each component individually may be clear and generally colorless, whereas upon mixing, the resulting composition has a cloudy or opaque appearance. Such a color change is beneficial, for example, as an indicator that the two components have been thoroughly mixed. Clear streaks would indicate regions of material that have not been thoroughly mixed.

The reactive composition, with the polyisocyanate component, the cyclic diol hard segment component, and any optional additives, usually has a solids level of at least about 20% and usually no more than about 75%. In some embodiments, the solids level is about 30-45%.

The reactive coating composition typically has a viscosity of about 0.08-0.19 Pascal seconds (80 to 190 cps), and usually about 0.12-0.15 Pascal seconds (120-150 cps). The coating composition is usually easy to apply, and readily flows to even out low spots. The reactive composition typically provides a thin, easily managed coating. Typically, only one pass with an applicator, such as applicator device 30, is needed to obtain a smooth an even coating. One pass is preferred, to inhibit the creation of air bubbles on the surface, which often form when multiple passes of the applicator device are made.

The reactive composition is easy to apply to a surface, such as a floor, using an application system such as system 10. A reactive composition coating thickness of usually no more than 5 mil (about 127 micrometers) is applied to the surface. In some embodiments, depending on the composition and the surface being coating, an applied coating of 2 mil (about 51 micrometers), or even an applied coating of about 1 mil (about 25 micrometers) provides a sufficient resulting coating. When cured and dried, the thickness of the resulting coating is usually no more than about 3 mil (about 76 micrometers), and often no more than about 2.5 mil (about 63 micrometers). If a primer composition is used as described above, it is generally desirable that the combined thickness of primer and cured and dried reactive coating be about 25.6 to about 81.3 micrometers (1.01-3.20 mils).

The drying and curing time for the coating composition depends on the specific individual components used in the composition, the coating thickness, and of course, temperature of the surface, temperature and humidity of the surrounding air, and the amount of air circulation in the immediate area of the applied reactive composition.

Upon drying and curing, the resulting coating has a high gloss and is highly durable. In many embodiments, the gloss of the dried coating is at least 85 at 60°, and in some embodiments, the gloss is at least 90 at 60°. In some embodiments, when a dried coating containing a cyclic diol is compared to a similar coating without the cyclic diol, the gloss at60° is at least 7 points higher.

Discussing now the individual components that form the reactive composition that results in the dried coating, the first component of the two-part composition is a polyisocyanate, more specifically, a water-dispersible polyisocyanate. It is known that isocyanates, in general, lose at least a portion of their reactivity when combined with water. The present disclosure, however, has achieved a water-based reactive composition with isocyanate that retains sufficient reactivity to provide a suitable, and improved, reactive coating composition and cured coating that is particularly suited for floors.

An example of a water-dispersible isocyanate that is commercially available is BAYHYDUR 302 from Bayer. BAYHYDUR 302 is a water-dispersible polyisocyanate based on hexamethylene diisocyanate (HDI), suitable for use as a hardener/crosslinker in waterborne reactive polyurethane systems for adhesives and coatings. According to Bayer, it has outstanding weather stability and gloss retention and is non-yellowing. The NCO content is 17.3%±0.5, the amount of solids is 99.8% minimum, and it has a viscosity of 2,300±700 mPa·s @ 25° C. Other water dispersable isocyanates can be substituted, such as RHODOCOAT X-EZ-D 401 from Rhodia or other water-dispersible aliphatic isocyanates.

The water-dispersible isocyanate is generally clear, having no appreciable opacity or color. This first component may include added to it optional additives and adjuvants which may alter the physical characteristics of the first component, however, the presence of optional additives is generally not preferred.

The first component in the waterborne side of the two-part composition includes a hydroxyl functionalized polymer that is a polyether, or polyester. These polymers make up the soft segment of the polyurethane. A number of different materials exist and are readily known to those skilled in the art. The polyol is usually supplied as a water dispersion in the solids range of 30 to 40%. A preferred polyol is a polyester available from Bayer under the designation BAYHYDUR XP 7093. It provides the non-yellowing, high gloss and chemical resistance needed in a floor coating.

The second component of the two-part composition is an aliphatic hard segment component, in many embodiments a cyclic aliphatic hard segment component. The hard segment is an alcohol, and in most embodiments, a primary alcohol.

A preferred cyclic alcohol for use in the reactive composition is a cyclic diol such as cyclohexanedimethanol, sometimes also referred to as cyclohexyldimethanol or as CHDM. In some embodiments, cyclohexanedimethanol is a solid at room temperature. This solid can be dissolved or dispersed in solvent, e.g., at room temperature to form a stable mixture. Most solutions of cyclohexanedimethanol have a mixture of the cis and trans forms.

A preferred cyclohexanedimethanol is 1,4-cyclohexanedimethanol, which is commercially available from, for example, Eastman under the designation CHDM-D Glycol, which is a symmetrical, high molecular weight cycloaliphatic glycol. CHDM-D90, also from Eastman, is a 90/10 weight percent solution of CHDM-D in water, and is liquid at room temperature.

The amount of active isocyanate and cyclic diol is typically similar, with molar ratios of isocyanate to cyclic diol generally being 2:1 to 1:2. In some embodiments, the two components are present in an actives weight ratio of about of 1.5:1 to 1:1.5, and in some embodiments about 1.25:1 to 1:1.25.

The reactive composition of the disclosure, with the isocyanate and cyclic diol components combined, typically has an actives content from about 25 to about 50 wt-%. In some embodiments, the actives are about 30 to 45 wt-%, and preferably are about 40 wt-% based on the weight of the reactive composition. It is not necessary to dilute the reactive composition after mixing, however, if done, the actives would typically be about 10-25 wt-% of the reactive composition. As used herein the term “active” or “active ingredient” means the ingredient alone or in combination has an effect on the polymerization of the composition. The active ingredients for the compositions of the present disclosure are the isocyanate and the cyclic diol. In contrast, “inactive” means the component is added primarily for aesthetic purposes, such as odor, color, and the like, or is an ingredient other than an isocyanate or a cyclic diol.

The pH of the reactive composition, with the two components mixed, is typically in the range of about 6 to about 10.5. In some embodiments, the pH is between about 7.5 and about 9.9. A pH adjuster (e.g., acids or bases) may be added to the composition to obtain the desired pH; typically, the composition is inherently acidic, so the pH is raised. The pH can be adjusted using various bases or buffering agents. Suitable bases or buffering agents include, for example, borax, sodium hydroxide, alkali phosphates, alkali silicates, alkali carbonates, ammonia, and amines such as diethanolamine or triethanolamine.

While not being bound herein, it is theorized that upon reaction with isocyanate, the cyclic diol hard segment forms a chain extending urethane linkage. It is also thought that the cyclohexane ring hard segment inverts at room temperature forming a rod-type void in the film. This allows the polymer chains, when cured, to distort and absorb impacts, which in turn resists abrasion. When more linear systems such as 1,4-butanediol (BDO) are used, the abrasion resistance is decreased; this supports the theory that the cyclic structure inverts.

A decrease in gloss of the cured coating is also observed when other diol hard segment chain extenders are used in place of cyclohexanedimethanol. This adds further evidence to the uniqueness of cyclohexanedimethanol as a hard segment chain extender.

In addition to the isocyanate and cyclic diol components, respectively, the individual components can also contain other ingredients such as polyvalent metal compounds, alkali-soluble resins, solvents, waxes, reactive or non-reactive acrylic compositions, reactive or non-reactive polyester compositions (such as polyester polyols), surfactants, permanent and fugitive plasticizers, defoamers, wetting agents, and biocides. Additionally or alternately, any optional ingredients may be added after the reactive composition has been formed by the mixing of the two individual components. The polyvalent metal compound provides crosslinking of the polymers in the film and increases the detergent resistance of the finish. Plasticizers or coalescing agents can be added to lower the temperature of film formation. Alkali-soluble resins improve the ability of the finish to be stripped from the substrate before reapplication of a fresh coating. Waxes can improve the mar resistance of the finish and allow the finish to be buffed. Reactive or non-reactive acrylic compositions can be added to aid leveling. Reactive or non-reactive polyester compositions can be added to improve chemical resistance, abrasion resistance and/or gloss. Surfactants can be added to aid leveling and wetting. Solvents can be added to aid the coatability of the reactive composition. Biocides help minimize the formation of molds or mildew in the coating. Antifoamers and defoamers minimize the formation of bubbles in the coating.

In addition to the above listed optional additives the composition may also contain particles. In particular particles of PTFE (polytetrafluoroethylene) are particularly useful. Generally, so as to not diminish the gloss of the final coating, the particles are typically relatively small, for example less than 0.5 micrometers. Such particles are commercially available as dispersions in water allowing for easy inclusion in the reactive coating compositions. Examples of useful, commercially available, particle dispersions include DYNEON TF 5032 from Dyneon; NANOFLON W 50C, Fluoro AQ-50, HYDROCERF 9174 from Shamrock and Lanco Glidd 3993 from Noveon. In addition the PTFE dispersion may contain waxes or other additives such as HYDROCER 6099 available from Shamrock which contains low molecular weight polyethylene wax.

After mixing of the two components, the resulting reactive composition can be applied to a variety of surfaces such as, for example, floors, walls, counter tops and shelving, furniture, and bathroom surfaces. Preferably, the substrate is a floor, but can be any surface upon which the coatable composition of the present disclosure can be applied. The surface can be generally any material, such as vinyl, linoleum, tile, ceramic, wood, marble, and the like.

After curing and drying (i.e., after complete reaction), the resultant coatings are smooth, exhibit increased hardness and modulus, and are highly resistant to scratches and soil. The resulting coatings are very durable.

### Examples

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted. All ASTM Test Methods used were the most recent version as of the date of filing of this disclosure unless otherwise noted.

Table of Abbreviations

| Abbreviation or Trade | | |
|---|---|---|
| Designation | Manufacturer | Description |
| BAYHYDUR 302 | Bayer | Water-dispersible polyisocyanate |
| BAYHYDROL XP | Bayer | Polyester dispersion |
| 7093 | | |
| ROSHIELD 3275 | Rohm & Haas | Acrylic emulsion |
| BYK 381 | Byk-Chemie | Surfactant |
| BYK 346 | Byk-Chemie | Silicone surfactant |
| DOWANOL PnB | Dow | Hydrophobic glycol ether |
| DABCO T12 | Air Products | Crosslinking Catalyst |
| ACRYSOL RM-8 | Rohm & Haas | Rheology modifier/thickener |
| QWF4744 | Henkel | Aliphatic waterborne Resin |
| DYNEON TF 5032 | Dyneon | PTFE (Polytetraflouroethylene) |
| | | dispersion |
| NANOFLON W50C | Shamrock | Nanoscale PTFE dispersion |
| FLOURO AQ-50 | Shamrock | Non-settling PTFE dispersion |
| HYDROCER 6099 | Shamrock | polyethylene wax/PTFE blend |
| | | dispersion |
| HYDROCERF9174 | Shamrock | 60% PTFE dispersion |
| DAPRO DF 7005 | Elementis | Waterborne Defoamer |
| DAPRO DF 3163 | Elementis | Water and solventborne |
| | | defoamer |
| BAYSILONE 3468 | Borchers | Polyether modified methyl |
| | | polysiloxane |
| BAYSILONE 3739 | Borchers | Polyether modified polysiloxane |
| LANCO GLIDD 6940 | Noveon | Water based synthetic wax |
| | | dispersion |
| LANCO GLIDD 3993 | Noveon | Water based PTFE dispersion |
| RHOPLEX NTS-2923 | Rohm & Haas | Acrylic polymer |
| RHOPLEX 2133 | Rohm & Haas | Modified acrylic polymer |
| | | emulsion |
| RHOPLEX WL-91 | Rohm & Haas | Thermoplastic acrylic polymer |
| | | emulsion |
| SW-CP-K | Lambent | Anionic silicone surfactant |
| SE-21 | Wacker | 10% silicone emulsion |
| | Chemie | (antifoam) |
| DOWANOL Glycol | Dow | Slow evaporating glycol ether |
| Ether | | |
| KP-140 | TCI | low viscosity trialky phosphate |
| | | (plasticizer) |
| CONLEX V | Morton | Acrylate polyer emulsion |
| | International | |
| DURAPLUS 2 | Rohm & Haas | Mixed Metal crosslinking |
| | | polymer |
| DURAGREEN MF1 | Rohm & Haas | Metal-free polymer |
| RESIN 5550 | Unocal Corp | Styrene-butadiene latex polymer |
| | | emulsion |
| KATHON CG/ICP | Rohm & Haas | Broad spectrum microbicide |
| POLYCAL AC325 | Mississippi | Calcium Carbonate emulsion |
| emulsion | Lime | |
| CHDM | | 1,4-Cyclohexanedimethanol |
| BDO | | butane diol |
| HDO | | hexane diol |
| MPDIOL | | 2,2-dimethyl 1,3 propanediol |
| HQEE | | hydroxymethylquinol ether |
| | | (aromatic) |
| MBOCA | | methylene bis- |
| | | metachlorodianaline |
| EDA | | ethylene diamine |
| EG | | Ethylene glycol |
| DEG | | diethylene glycol |
| NOVEC FC-4430 | 3M Company | Fluorosurfactant |
| DURAGREEN MF-1 | Rohm & Haas | Metal-free floor finish polymer |
| HYDROSIL 2776 | Degussa | Water-based silane |
| SYNTRAN 1921 | Interpolymer | Acrylic copolymer |
| Z-6137 | Dow Corning | Amino-functional siloxane |
| | | polymer solution |
| Z-6020 | Dow Corning | Silane coupling agent |
| Z-6011 | Dow Corning | Amino-functional alkoxy silane |

### Test Methods

### Gloss Measurement

Reactive coating compositions were applied to a vinyl composition tile and allowed to react and dry to provide a 2 mil (about 51 micrometer) thick coating. Twenty-four hours after coating, the gloss of the coating was measured with a BYK Gardner Gloss Meter using ASTM D 1455 (at 60°). These measurements are reported as Initial Gloss. In some examples the 60° Gloss was measured and given a rating on a 1-5 scale with the rating values:

5 gloss of >95

4 gloss of 85-95

3 gloss of 70-84

2 gloss of 69-70

1 gloss of <60

### Abraded Gloss Test Method

Reactive coating compositions were applied to a vinyl composition tile and allowed to react and dry to provide a 2 mil (about 51 micrometer) thick coating as described for the Gloss Measurement test method above. The coated, vinyl composition tiles were abraded and the gloss of the coating was again measured and is reported as

Abraded Gloss. The abrasion was conducted following ASTM D3206-87. The soil used was modified by adding 20 wt % of playground sand found at local hardware stores. The sand was dried in a 120° C. forced-air oven. The tiles were wiped with a soft damp cloth and then read using a Gloss Meter as described for the Gloss Measurement test method above at 60°.

### Stripability Test

Coated vinyl composition tiles were tested for the removability of the coating and primer using a modification of the test method ASTM D 1792. The tiles were stripped using 3M SPEED STRIPPER commercially available from 3M Company, St. Paul, Minn. using 20 passes of the stripping pad. The tiles were then examined to determine whether the coating was removed and ranked “Pass” if at least 20% of the coating was removed or “Fail” if less than 20% of the coating was removed.

### Synthesis Examples

### Primer 1

A primer coating composition was prepared with the ingredients shown in Table A.

TABLE A

| | Amount |
|---|---|
| Reagent | (grams) |
| D.I. Water | 56.527 |
| SW-CP-K | 0.800 |
| SE-21 | 0.030 |
| KATHONCG/ICP | 0.033 |
| DOWANOL Glycol | 0.680 |
| Ether | |
| KP-140 | 1.320 |
| CONLEX V | 16.300 |
| Emulsion | |
| Resin 5550 | 2.730 |
| AC325 Emulsion | 5.287 |
| DURAPLUS 2 | 16.300 |

### Primer 2

A primer coating composition was prepared with the ingredients shown in Table B.

TABLE B

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAPLUS 2 | 16.300 |
| ROSHIELD 3275 | 14.000 |

### Primer 3

A primer coating composition was prepared with the ingredients shown in Table C.

TABLE C

| | Amount |
|---|---|
| Reagent | (grams) |
| Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAPLUS 2 | 16.300 |
| Z-6137 | 0.900 |

### Primer 4

A primer coating composition was prepared with the ingredients shown in Table D.

TABLE D

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAGREEN MF-1 | 16.300 |
| HYDROSIL 2776 | 0.900 |

### Primer 5

A primer coating composition was prepared with the ingredients shown in Table E.

TABLE E

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAGREEN MF-1 | 16.300 |
| Z-6020 | 0.900 |

### Primer 6

A primer coating composition was prepared with the ingredients shown in Table F.

TABLE F

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAGREEN MF-1 | 16.300 |
| Z-6011 | 0.900 |

### Primer 7

A primer coating composition was prepared with the ingredients shown in Table G.

TABLE G

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| DURAGREEN MF-1 | 16.300 |
| Z-6137 | 0.900 |

### Primer 8

A primer coating composition was prepared with the ingredients shown in Table H.

### Example 1

TABLE H

| | Amount |
|---|---|
| Reagent | (grams) |
| D.I. Water | 56.527 |
| SW-CP-K | 0.800 |
| SE-21 | 0.030 |
| DOWANOL Glycol | 0.680 |
| Ether | |
| KP-140 | 1.320 |
| CONLEX V | 16.300 |
| Emulsion | |
| SYNTRAN 1921 | 16.300 |
| Z-6011 | 0.900 |

Example 1 was prepared by providing a water-dispersible polyisocyanate component (i.e., Component A in Table 1, below) and a cyclohexane diol hard segment component, (i.e., Component B in Table 2). Component B was prepared by mixing together, in the order listed, the listed ingredients at the provided amounts, except for the DOWANOL surfactant which was first mixed into the water. Both Component A and Component B, individually, were clear. Upon combination of the two Components, the resulting reactive composition was milky white. Example 1 was tested according to the Gloss Measurement test method and Abraded Gloss Test Method shown above. The results are presented in Table 3.

TABLE 1
Component A

| Ingredient | mass (g) | moles | Equiv. Wt |
|---|---|---|---|
| BAYHYDUR 302 | 44.00 | 0.1811 | 243.00 |

TABLE 2
Component B

| Ingredient | mass (g) | moles | Equiv. Wt |
|---|---|---|---|
| Trimethylol propane (75%) | 0.33 | 0.0054 | 61.59 |
| BAYHYDUR XP 7093 polyester resin | 42.69 | 0.0374 | 1140.00 |
| CHDM | 7.15 | 0.0754 | 94.81 |
| Water | 2 | 0.1111 | 18 |
| Triethylamine | 0.31 | 0.0031 | 101.19 |
| Water | 100 | 5.5556 | 18 |
| DOWANOL PnB | 3 | 0.0227 | 132.2 |
| BYK 346 | 0.33 | — | — |
| BYK 381 | 0.33 | — | — |

### Comparative Examples C1-C10

For Comparative Examples C1-C9 reactive compositions were made, using the formula described in Example 1, but with the cyclic diol identified in Table 3 in place of the cyclohexanedimethanol. For Comparative Example C10 a commercially available product “GlossTek” from Ecolab was used. Comparative Examples C1-C10 were tested according to the Gloss Measurement test method and Abrasion Test Method shown above. The results are presented in Table 3.

TABLE 3

| | | | Abraded |
|---|---|---|---|
| Example | Diol | Initial Gloss | Gloss |
| 1 | CHDM | 94 | 90 |
| C1 | BDO | 80 | NA |
| C2 | HDO | 85 | 80 |
| C3 | MPDIOL | 89 | 86 |
| C4 | HQEE | 40 | NA |
| C5 | MBOCA | 0 | NA |
| C6 | EDA | 0 (gelled) | NA |
| C7 | EG | 0 | NA |
| C8 | DEG | 0 | NA |
| C9 | None | 87 | 60 |
| C10 | “GlossTek” | 86 | 78 |
| | from Ecolab | | |

For the abraded results recorded as “NA”, the films were too tacky to obtain gloss readings.

### Examples 2-28

For Examples 2-28 the same procedure for preparing and testing reactive coating compositions described in Example 1 was followed except that the coating composition was coated over a pre-primed tile surface. For each Example the primer used and the reactive coating composition ingredients are listed.

### Example 2

Example 2 was prepared by providing Component A in Table 4, below and Component B in Table 5 similarly to the procedure for Example 1. Both Component A and Component B, individually, were clear. Upon combination of the two Components, the resulting reactive composition was milky white. Example 2 was tested according to the Gloss Measurement test method shown above except that Primer 1 was applied to the sample tile and dried prior to the application of Example 2. The results are presented in Table 58.

TABLE 4
Component A

| Ingredient | mass (g) | Equiv. wt | Moles |
|---|---|---|---|
| BAYHYDUR 302 | 48.00 | 243.00 | 0.1975 |

TABLE 5
Component B

| Ingredient | mass (g) | Equiv. wt | Moles |
|---|---|---|---|
| BAYHYDROL XP 7093 | 84.91 | 1140.00 | 0.0745 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |

### Example 3

Example 3 was prepared by providing Component A in Table 6, below and Component B in Table 7 similarly to the procedure for Example 1. Both Component A and Component B, individually, were clear. Upon combination of the two Components, the resulting reactive composition was milky white. Example 3 was tested according to the Gloss Measurement test method shown above except that Primer 1 was applied to the sample tile and dried prior to the application of Example 3. The results are presented in Table 58.

TABLE 6
Component A

| Ingredient | mass (g) | Equiv. wt | Moles |
|---|---|---|---|
| BAYHYDUR 302 | 48.00 | 243.00 | 0.1975 |

TABLE 7
Component B

| Ingredient | mass (g) | Equiv. wt | Moles |
|---|---|---|---|
| BAYHYDROL XP 7093 | 84.91 | 1140.00 | 0.0745 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |
| DABCO T12 | 0.02 | — | — |

### Example 4

Example 4 was prepared by providing Component A in Table 8, below and Component B in Table 9 similarly to the procedure for Example 1. Both Component A and Component B, individually, were clear. Upon combination of the two Components, the resulting reactive composition was milky white. Example 4 was tested according to the Gloss Measurement test method shown above except that Primer 1 was applied to the sample tile and dried prior to the application of Example 4. The results are presented in Table 58.

TABLE 8
Component A

| Ingredient | mass (g) | Equiv. wt | moles |
|---|---|---|---|
| BAYHYDUR 302 | 48.00 | 243.00 | 0.1975 |
| DABCO T12 | 0.02 | — | — |

TABLE 9
Component B

| Ingredient | mass (g) | Equiv. wt | moles |
|---|---|---|---|
| BAYHYDROL XP 7093 | 84.91 | 1140.00 | 0.0745 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |

### Example 5

Example 5 was prepared by providing Component A in Table 10, below and Component B in Table 11 similarly to the procedure for Example 1. Both Component A and Component B, individually, were clear. Upon combination of the two Components, the resulting reactive composition was milky white. Example 5 was tested according to the Gloss Measurement test method shown above except that Primer 1 was applied to the sample tile and dried prior to the application of Example 5. The results are presented in Table 58.

TABLE 10
Component A

| Ingredient | mass (g) | Equiv. wt | moles |
|---|---|---|---|
| BAYHYDUR 302 | 48.00 | 243.00 | 0.1975 |
| DABCO T12 | 0.02 | — | — |

TABLE 11
Component B

| Ingredient | mass (g) | Equiv. wt | moles |
|---|---|---|---|
| BAYHYDROL XP 7093 | 84.91 | 1140.00 | 0.0745 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |
| RM-8 Thickener | 1.80 | — | — |

### Example 6

Example 6 was prepared by providing Component A in Table 12, below and Component B in Table 13 similarly to the procedure for Example 1. Both Component A and Component B, individually, were clear. Upon combination of the two Components, the resulting reactive composition was milky white. Example 6 was tested according to the Gloss Measurement test method shown above except that Primer 1 was applied to the sample tile and dried prior to the application of Example 6. The results are presented in Table 58.

TABLE 12
Component A

| Ingredient | mass (g) | Equiv. wt | moles |
|---|---|---|---|
| QWF4744 | 48.00 | 243.00 | 0.1975 |

TABLE 13
Component B

| Ingredient | mass (g) | Equiv. wt | moles |
|---|---|---|---|
| BAYHYDROL XP 7093 | 84.91 | 1140.00 | 0.0745 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |

### Example 7

Example 7 was prepared by providing Component A in Table 14, below and Component B in Table 15 similarly to the procedure for Example 1. Both Component A and Component B, individually, were clear. Upon combination of the two Components, the resulting reactive composition was milky white. Example 7 was tested according to the Gloss Measurement test method shown above except that Primer 1 was applied to the sample tile and dried prior to the application of Example 7. The results are presented in Table 58.

TABLE 14
Component A

| Ingredient | mass (g) | Equiv. wt | moles |
|---|---|---|---|
| BAYHYDUR 302 | 48.00 | 243.00 | 0.1975 |

TABLE 15
Component B

| Ingredient | mass (g) | Equiv. wt | moles |
|---|---|---|---|
| BAYHYDROL XP 7093 | 84.91 | 1140.00 | 0.0745 |
| ROSHIELD 3275 | 112.95 | 3275.00 | 0.0345 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 3.55 | 94.81 | 0.0374 |
| BYK 346 | 0.33 | — | — |
| BYK 381 | 0.33 | — | — |
| DOWANOL PnB | 3.50 | 132.2 | 0.0265 |

### Example 8

Example 8 was prepared by providing Component A in Table 16, below and Component B in Table 17 similarly to the procedure for Example 1. Both Component A and Component B, individually, were clear. Upon combination of the two Components, the resulting reactive composition was milky white. Example 8 was tested according to the Gloss Measurement test method shown above except that Primer 1 was applied to the sample tile and dried prior to the application of Example 8. The results are presented in Table 58.

TABLE 16
Component A

| Ingredient | mass (g) | Equiv. wt | moles |
|---|---|---|---|
| BAYHYDUR 302 | 48.00 | 243.00 | 0.1975 |

TABLE 17
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |

### Example 9

Example 9 was prepared by providing Component A in Table 18, below and Component B in Table 19 similarly to the procedure for Example 1. Both Component A and Component B, individually, were clear. Upon combination of the two Components, the resulting reactive composition was milky white. Example 9 was tested according to the Gloss Measurement test method shown above except that Primer 1 was applied to the sample tile and dried prior to the application of Example 9. The results are presented in Table 58.

TABLE 18
Component A

| Ingredient | mass (g) | Equiv. wt | moles |
|---|---|---|---|
| BAYHYDUR 302 | 48.00 | 243.00 | 0.1975 |

TABLE 19
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| DYNEON TF 5032 | 2.15 | — | — |

### Example 10

Example 10 was prepared by providing Component A in Table 20, below and Component B in Table 21 similarly to the procedure for Example 1. Both Component A and Component B, individually, were clear. Upon combination of the two Components, the resulting reactive composition was milky white. Example 10 was tested according to the Gloss Measurement test method shown above except that Primer 1 was applied to the sample tile and dried prior to the application of Example 10. The results are presented in Table 58.

TABLE 20
Component A

| Ingredient | mass (g) | Equiv. wt | moles |
|---|---|---|---|
| BAYHYDUR 302 | 48.00 | 243.00 | 0.1975 |

TABLE 21
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| NANOFLON | 7.50 | — | — |

### Example 11

Example 11 was prepared by providing Component A in Table 22, below and Component B in Table 23 similarly to the procedure for Example 1. Both Component A and Component B, individually, were clear. Upon combination of the two Components, the resulting reactive composition was milky white. Example 11 was tested according to the Gloss Measurement test method shown above except that Primer 1 was applied to the sample tile and dried prior to the application of Example 11. The results are presented in Table 58.

TABLE 22
Component A

| Ingredient | mass (g) | Equiv. wt | moles |
|---|---|---|---|
| BAYHYDUR 302 | 48.00 | 243.00 | 0.1975 |

TABLE 23
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| FLUORO AQ | 2.15 | — | — |

### Example 12

Example 12 was prepared by providing Component A in Table 24, below and Component B in Table 25 similarly to the procedure for Example 1. Both Component A and Component B, individually, were clear. Upon combination of the two Components, the resulting reactive composition was milky white. Example 12 was tested according to the Gloss Measurement test method shown above except that Primer 1 was applied to the sample tile and dried prior to the application of Example 12. The results are presented in Table 58.

TABLE 24
Component A

| Ingredient | mass (g) | Equiv. wt | moles |
|---|---|---|---|
| BAYHYDUR 302 | 48.00 | 243.00 | 0.1975 |

TABLE 25
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| HYDROCER 6099 | 2.75 | — | — |

### Example 13

Example 13 was prepared by providing Component A in Table 26, below and Component B in Table 27 similarly to the procedure for Example 1. Both Component A and Component B, individually, were clear. Upon combination of the two Components, the resulting reactive composition was milky white. Example 13 was tested according to the Gloss Measurement test method shown above except that Primer 1 was applied to the sample tile and dried prior to the application of Example 13. The results are presented in Table 58.

TABLE 26
Component A

| Ingredient | mass (g) | Equiv. wt | moles |
|---|---|---|---|
| BAYHYDUR 302 | 48.00 | 243.00 | 0.1975 |

TABLE 27
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| HYDROCERF 9174 | 2.75 | — | — |

### Example 14

Example 14 was prepared by providing Component A in Table 28, below and Component B in Table 29 similarly to the procedure for Example 1. Both Component A and Component B, individually, were clear. Upon combination of the two Components, the resulting reactive composition was milky white. Example 14 was tested according to the Gloss Measurement test method shown above except that Primer 1 was applied to the sample tile and dried prior to the application of Example 14. The results are presented in Table 58.

TABLE 28
Component A

| Ingredient | mass (g) | Equiv. wt | moles |
|---|---|---|---|
| BAYHYDUR 302 | 48.00 | 243.00 | 0.1975 |

TABLE 29
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane (75%) | 0.33 | 61.59 | 0.0054 |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| DAPRO DF 7005 | 0.20 | — | — |

### Example 15

Example 15 was prepared by providing Component A in Table 30, below and Component B in Table 31 similarly to the procedure for Example 1. Both Component A and Component B, individually, were clear. Upon combination of the two Components, the resulting reactive composition was milky white. Example 15 was tested according to the Gloss Measurement test method shown above except that Primer 1 was applied to the sample tile and dried prior to the application of Example 15. The results are presented in Table 58.

TABLE 30
Component A

| Ingredient | mass (g) | Equiv. wt | moles |
|---|---|---|---|
| BAYHYDUR 302 | 48.00 | 243.00 | 0.1975 |

TABLE 31
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| DAPRO DF 3163 | 0.20 | — | — |

### Example 16

Example 16 was prepared by providing Component A in Table 32, below and Component B in Table 33 similarly to the procedure for Example 1. Both Component A and Component B, individually, were clear. Upon combination of the two Components, the resulting reactive composition was milky white. Example 16 was tested according to the Gloss Measurement test method shown above except that Primer 1 was applied to the sample tile and dried prior to the application of Example 16. The results are presented in Table 58.

TABLE 32
Component A

| Ingredient | mass (g) | Equiv. wt | moles |
|---|---|---|---|
| BAYHYDUR 302 | 48.00 | 243.00 | 0.1975 |

TABLE 33
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| BAYSILONE 3468 | 1.50 | — | — |

### Example 17

Example 17 was prepared by providing Component A in Table 34, below and Component B in Table 35 similarly to the procedure for Example 1. Both Component A and Component B, individually, were clear. Upon combination of the two Components, the resulting reactive composition was milky white. Example 17 was tested according to the Gloss Measurement test method shown above except that Primer 1 was applied to the sample tile and dried prior to the application of Example 17. The results are presented in Table 58.

TABLE 34
Component A

| Ingredient | mass (g) | Equiv. wt | moles |
|---|---|---|---|
| BAYHYDUR 302 | 48.00 | 243.00 | 0.1975 |

TABLE 35
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| BAYSILONE 3739 | 0.15 | — | — |

### Example 18

Example 18 was prepared by providing Component A in Table 36, below and Component B in Table 37 similarly to the procedure for Example 1. Both Component A and Component B, individually, were clear. Upon combination of the two Components, the resulting reactive composition was milky white. Example 18 was tested according to the Gloss Measurement test method shown above except that Primer 1 was applied to the sample tile and dried prior to the application of Example 18. The results are presented in Table 58.

TABLE 36
Component A

| Ingredient | mass (g) | Equiv. wt | moles |
|---|---|---|---|
| BAYHYDUR 302 | 48.00 | 243.00 | 0.1975 |

TABLE 37
Component B

| Ingredient | mass (g) | Equiv. wt | moles |
|---|---|---|---|
| BAYHYDROL XP 7093 | 121.17 | 1140.00 | 0.1063 |
| ROSHIELD 3275 | 9.00 | 3275.00 | 0.0027 |
| Water | 80.00 | 18.00 | 4.444 |
| Triethylamine | 0.31 | 101.19 | 0.0031 |
| Trimethylol propane | 0.33 | 61.59 | 0.0054 |
| (75%) | | | |
| CHDM | 0.05 | 94.81 | 0.0005 |
| BYK 346 | 0.33 | — | — |
| BYK 381 | 0.33 | — | — |
| DOWANOL PnB | 3.50 | 132.2 | 0.0265 |
| BAYSILONE 3468 | 2.15 | — | — |

### Example 19

Example 19 was prepared by providing Component A in Table 38, below and Component B in Table 39 similarly to the procedure for Example 1. Both Component A and Component B, individually, were clear. Upon combination of the two Components, the resulting reactive composition was milky white. Example 19 was tested according to the Gloss Measurement test method shown above except that Primer 1 was applied to the sample tile and dried prior to the application of Example 19. The results are presented in Table 58.

TABLE 38
Component A

| Ingredient | mass (g) | Equiv. wt | moles |
|---|---|---|---|
| BAYHYDUR 302 | 48.00 | 243.00 | 0.1975 |

TABLE 39
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |

### Example 20

Example 20 was prepared by providing Component A in Table 40, below and Component B in Table 41 similarly to the procedure for Example 1. Both Component A and Component B, individually, were clear. Upon combination of the two Components, the resulting reactive composition was milky white. Example 20 was tested according to the Gloss Measurement test method shown above except that Primer 1 was applied to the sample tile and dried prior to the application of Example 20. The results are presented in Table 58.

TABLE 40
Component A

| Ingredient | mass (g) | Equiv. wt | moles |
|---|---|---|---|
| BAYHYDUR 302 | 48.00 | 243.00 | 0.1975 |

TABLE 41
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| LANCO GLIDD 6940 | 2.28 | — | — |

### Example 21

Example 21 was prepared by providing Component A in Table 42, below and Component B in Table 43 similarly to the procedure for Example 1. Both Component A and Component B, individually, were clear. Upon combination of the two Components, the resulting reactive composition was milky white. Example 21 was tested according to the Gloss Measurement test method shown above except that Primer 1 was applied to the sample tile and dried prior to the application of Example 21. The results are presented in Table 58.

TABLE 42
Component A

| Ingredient | mass (g) | Equiv. wt | moles |
|---|---|---|---|
| BAYHYDUR 302 | 48.00 | 243.00 | 0.1975 |

TABLE 43
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| LANCO GLIDD 3993 | 2.28 | — | — |

### Example 22

Example 22 was prepared by providing Component A in Table 44, below and Component B in Table 45 similarly to the procedure for Example 1. Both Component A and Component B, individually, were clear. Upon combination of the two Components, the resulting reactive composition was milky white. Example 22 was tested according to the Gloss Measurement test method shown above except that Primer 1 was applied to the sample tile and dried prior to the application of Example 22. The results are presented in Table 58.

TABLE 44
Component A

| Ingredient | mass (g) | Equiv. wt | moles |
|---|---|---|---|
| BAYHYDUR 302 | 48.00 | 243.00 | 0.1975 |

TABLE 45
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| LANCO GLIDD 3993 | 2.28 | — | — |
| RHOPLEX 2133 | 2.28 | — | — |

### Example 23

Example 23 was prepared by providing Component A in Table 46, below and Component B in Table 47 similarly to the procedure for Example 1. Both Component A and Component B, individually, were clear. Upon combination of the two Components, the resulting reactive composition was milky white. Example 23 was tested according to the Gloss Measurement test method shown above except that Primer 2 was applied to the sample tile and dried prior to the application of Example 23. The results are presented in Table 58.

TABLE 46
Component A

| Ingredient | mass (g) | Equiv. wt | moles |
|---|---|---|---|
| BAYHYDUR 302 | 52.20 | 243.00 | 0.2148 |

TABLE 47
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |

### Example 24

Example 24 was prepared by providing Component A in Table 48, below and Component B in Table 49 similarly to the procedure for Example 1. Both Component A and Component B, individually, were clear. Upon combination of the two Components, the resulting reactive composition was milky white. Example 24 was tested according to the Gloss Measurement test method shown above except that Primer 1 was applied to the sample tile and dried prior to the application of Example 24. The results are presented in Table 58.

TABLE 48
Component A

| Ingredient | mass (g) | Equiv. wt | moles |
|---|---|---|---|
| BAYHYDUR 302 | 48.00 | 243.00 | 0.1975 |

TABLE 49
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| RHOPLEX NTS-2923 | 31.00 | — | — |

### Example 25

Example 25 was prepared by providing Component A in Table 50, below and Component B in Table 51 similarly to the procedure for Example 1. Both Component A and Component B, individually, were clear. Upon combination of the two Components, the resulting reactive composition was milky white. Example 25 was tested according to the Gloss Measurement test method shown above except that Primer 1 was applied to the sample tile and dried prior to the application of Example 25. The results are presented in Table 58.

TABLE 50
Component A

| Ingredient | mass (g) | Equiv. wt | moles |
|---|---|---|---|
| BAYHYDUR 302 | 48.00 | 243.00 | 0.1975 |

TABLE 51
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| RHOPLEX WI-91 | 31.00 | — | — |

### Example 26

Example 26 was prepared by providing Component A in Table 52, below and Component B in Table 53 similarly to the procedure for Example 1. Both Component A and Component B, individually, were clear. Upon combination of the two Components, the resulting reactive composition was milky white. Example 26 was tested according to the Gloss Measurement test method shown above except that Primer 1 was applied to the sample tile and dried prior to the application of Example 26. The results are presented in Table 58.

TABLE 52
Component A

| Ingredient | mass (g) | Equiv. wt | moles |
|---|---|---|---|
| BAYHYDUR 302 | 48.00 | 243.00 | 0.1975 |

TABLE 53
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |
| NOVEC FC-4430 | 0.31 | — | — |
| DOWANOL PnB | 19.38 | — | — |

### Example 27

Example 27 was prepared by providing Component A in Table 54, below and Component B in Table 55 similarly to the procedure for Example 1. Both Component A and Component B, individually, were clear. Upon combination of the two Components, the resulting reactive composition was milky white. Example 27 was tested according to the Gloss Measurement test method shown above except that Primer 1 was applied to the sample tile and dried prior to the application of Example 27. The results are presented in Table 58.

TABLE 54
Component A

| Ingredient | mass (g) | Equiv. wt | moles |
|---|---|---|---|
| BAYHYDUR 302 | 48.00 | 243.00 | 0.1975 |

TABLE 55
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 80.00 | 18.00 | 4.444 |
| Triethylamine | 0.50 | 101.19 | 0.0049 |
| CHDM | 1.00 | 94.81 | 0.0105 |
| NOVEC FC-4430 | 0.31 | — | — |
| DOWANOL PnB | 19.38 | — | — |

### Example 28

Example 28 was prepared by providing Component A in Table 56, below and Component B in Table 57 similarly to the procedure for Example 1. Both Component A and Component B, individually, were clear. Upon combination of the two Components, the resulting reactive composition was milky white. Example 28 was tested according to the Gloss Measurement test method shown above except that Primer 1 was applied to the sample tile and dried prior to the application of Example 28. The results are presented in Table 58.

TABLE 56
Component A

| Ingredient | mass (g) | Equiv. wt | moles |
|---|---|---|---|
| BAYHYDUR 302 | 48.00 | 243.00 | 0.1975 |

TABLE 57
Component B

| Ingredient | mass (g) | Equiv. wt | moles |
|---|---|---|---|
| BAYHYDROL XP 7093 | 121.15 | 1140.00 | 0.1063 |
| ROSHIELD 3275 | 24.00 | 3275.00 | 0.0073 |
| Water | 107.66 | 18.00 | 5.9811 |
| Triethylamine | 0.50 | 101.19 | 0.0049 |
| CHDM | 1.00 | 94.81 | 0.0105 |
| BYK 346 | 1.00 | — | — |
| BYK 381 | 1.00 | — | — |

TABLE 58

| Example | 60° Gloss Rating Value |
|---|---|
| 2 | 4 |
| 3 | 2 |
| 4 | 4 |
| 5 | 1 |
| 6 | 2 |
| 7 | 3 |
| 8 | 3 |
| 9 | 4 |
| 10 | 4 |
| 11 | 4 |
| 12 | 3 |
| 13 | 3 |
| 14 | 2 |
| 15 | 2 |
| 16 | 4 |
| 17 | 4 |
| 18 | 4 |
| 19 | 4 |
| 20 | 3 |
| 21 | 3 |
| 22 | 4 |
| 23 | 4 |
| 24 | 3 |
| 25 | 3 |
| 26 | 4 |
| 27 | 4 |
| 28 | 4 |

### Examples 29-34

For Examples 29-34, vinyl composite tiles were coated with a primer composition, dried and coated with a test coating formulation from one of the Examples listed above. The coated tile was then tested using the Strippability test method given above. The data are presented in Table 59.

TABLE 59

| | Primer Composition | Reactive Coating | Strippability Test |
|---|---|---|---|
| Example | Used | Composition | Result |
| 29 | C | Example 19 | Pass |
| 30 | D | Example 19 | Pass |
| 31 | E | Example 19 | Pass |
| 32 | F | Example 19 | Pass |
| 33 | G | Example 19 | Pass |
| 34 | H | Example 19 | Pass |

What is claimed:

1. A reactive composition comprising:
a first component comprising a water-dispersible isocyanate; and
a second component comprising cyclohexanedimethanol and water.

2. The composition of claim 1, wherein the cyclohexanedimethanol comprises 1,4-cyclohexanedimethanol.

3. The composition of claim 1 wherein the first component comprises a water-dispersible polyisocyanate based on hexamethylene diisocyanate.

4. The composition of claim 1 comprising an actives ratio of the water-dispersible isocyanate to the cyclohexanedimethanol of about 2:1 to about 1:2.

5. The composition of claim 1 further comprising at least one other ingredient selected from polyvalent metal compounds, alkali-soluble resins, solvents, waxes, reactive or non-reactive acrylic compositions, reactive or non-reactive polyester compositions, surfactants, permanent and fugitive plasticizers, defoamers, wetting agents, and biocides.

6. The composition of claim 1 further comprising a water-dispersible polyester polyol.

7. The composition of claim 1 wherein the composition when cured retains a 60° gloss of 90 or greater when measured using a gloss meter and using the test method ASTM D 1455.

8. A method of making a reactive composition comprising:
providing a first component comprising a water-dispersible isocyanate in a first vessel;
providing a second component comprising cyclohexanedimethanol and water in a second vessel; and
combining the first component with the second component to provide the reactive composition, and wherein the first vessel and the second vessel comprise adjacent compartments in a multi-compartment plastic bag or pouch wherein there is at least one rupturable inner seal between the adjacent compartments and wherein combining comprises rupturing the inner seal between the adjacent compartments.

9. The method of claim 8 wherein combining further comprises mixing by kneading.

10. The method of claim 8, wherein the second component comprises 1,4-cyclohexanedimethanol.

11. A method of applying a reactive composition to a surface comprising:
combining a first component comprising a water-dispersible isocyanate with a second component comprising a cyclohexanedimethanol and water to provide the reactive composition; and
applying the composition to a surface.

12. The method of claim 11, wherein the surface is a floor.

13. The method of claim 12, wherein applying the reactive composition to a floor comprises:
applying the reactive composition at a thickness of no more than about 127 micrometers (5 mil).

14. The method of claim 12, wherein applying the reactive composition comprises:
applying the reactive composition at a thickness of more than about 51 micrometers (2 mil).

15. The method of claim 11, further comprising applying a primer to the surface prior to the application of the reactive composition.

16. The method of claim 15 wherein the primer comprises an acrylic latex and an alkali-soluble resin.

17. The method of claim 15 wherein the primer, when dried, has a thickness of from about 0.254 to about 5.08 micrometers (0.01-0.2 mils).

18. The method of claim 15 wherein the combined thickness, when dried, of primer and reactive composition is from about 25.6 to about 81.3 micrometers (1.01-3.2 mils).

19. The method of claim 15 wherein the primer is applied as a single coat.

20. A method for stripping a coated surface comprising:
applying a stripper to the coated surface; and
removing at least a portion of the surface coating,
wherein the coated surface comprises:
a surface with a coating, the coating comprising:
a primer coating layer and a reactive composition coating layer on top of the primer coating layer, wherein the reactive composition coating layer comprises a urethane coating formed from the reaction of a water-dispersible isocyanate and a cyclohexanedimethanol.

21. The method of claim 20 wherein the primer coating layer and reactive composition coating layer have a combined thickness, when dried, of from about 25.6 to about 81.3 micrometers (1.01-3.20 mils).

22. The method of claim 20 wherein the primer coating layer comprises an acrylic polymer and an alkali-soluble resin.

23. A coated surface comprising a surface, at least one coating of a primer composition on the surface and at least one coating of a reactive composition over the primer composition comprising:
a first component comprising a water-dispersible isocyanate; and
a second component comprising a cyclohexanedimethanol and water.

24. The coated surface of claim 23 wherein the primer comprises an acrylic latex and an alkali-soluble resin.

25. A kit for coating a surface comprising:
a vessel containing a primer; and
a vessel containing a reactive coating composition, wherein the primer comprises:
an acrylic latex and an alkali-soluble resin and wherein the reactive coating composition comprises:
a first component comprising a water-dispersible isocyanate, and a second component comprising a cyclohexanedimethanol and water.

26. The kit of claim 25 wherein the vessel containing the reactive coating composition comprises a multi-compartment plastic bag or pouch wherein the first component and the second component are in adjacent compartments with at least one rupturable inner seal between the adjacent compartments.

27. The kit of claim 25 further comprising a vessel containing a stripper.

28. A method for treating a surface comprising:
applying a primer composition;
permitting the primer composition to dry;
applying a reactive coating composition to the dried primer surface;
permitting the reactive coating composition to react and dry; and
stripping off the primer and coating composition layers with a stripper, wherein the reactive coating composition comprises:
a water-dispersible isocyanate, a cyclohexanedimethanol and water.
